(19) United States
(12) Patent Application Publication
(10) Pub. No.: US 2017/0025682 A1
(43) Pub. Date: Jan. 26, 2017

(54) ELECTRODE PLATE, AND ELECTRODE ASSEMBLY AND SECONDARY BATTERY, EACH INCLUDING THE SAME

(71) Applicant: Samsung Electronics Co., Ltd., Suwon-si (KR)

(72) Inventors: Sangmin Ji, Yongin-si (KR); Junhwan Ku, Seongnam-si (KR); Jeongkuk Shon, Hwaseong-si (KR); Minsang Song, Seongnam-si (KR); Jaejun Chang, Seoul (KR); Seungsik Hwang, Seongnam-si (KR); Moonseok Kwon, Hwaseong-si (KR); Jaeman Choi, Seongnam-si (KR)

(21) Appl. No.: 15/149,592

(22) Filed: May 9, 2016

(30) Foreign Application Priority Data
Jul. 20, 2015 (KR) 10-2015-0102407

(51) Int. Cl. H01M 4/70; H01M 4/13; H01M 4/04; H01M 10/0525

(52) U.S. Cl. CPC H01M 4/70; H01M 10/0525; H01M 4/13; H01M 4/0404; H01M 2004/021

(57) ABSTRACT

An electrode plate includes an electrode structure, the electrode structure including: a current collector; an electrode active material layer disposed on at least a portion of the current collector; and at least one slit which extends from a first side surface of the electrode structure to a point on a top surface of the electrode structure, wherein the at least one slit extends through the electrode active material layer. Also an electrode assembly and a secondary battery each include the electrode plate.

### CROSS-REFERENCE TO RELATED APPLICATION

This application claims priority to and the benefit of Korean Patent Application No. 10-2015-0102407, filed on Jul. 20, 2015, in the Korean Intellectual Property Office, and all the benefits accruing therefrom under 35 U.S.C. §119, the content of which is incorporated herein in its entirety by reference.

### BACKGROUND

1. Field

The present disclosure relates to an electrode plate, an electrode assembly including the electrode plate, and a secondary battery including the electrode plate.

2. Description of the Related Art

In response to advances in electronics, the market for portable electronic devices, such as smart watches, smart phones, smart pads, terminals for electronic books, tablet computers, or wearable devices being attachable to the human body, as well as mobile phones, game devices, portable multimedia players (PMP), or mpeg audio layer-3 (MP3) players, has been rapidly growing. The growing market for portable electronic devices has led to a high demand for batteries that are suitable for powering portable electronic devices.

Secondary batteries are rechargeable, unlike primary batteries that are not rechargeable. Also, lithium secondary batteries have higher voltage and higher energy density than nickel-cadmium batteries or nickel-hydrogen batteries. Nonetheless, there remains a need for improved battery components and improved batteries.

### SUMMARY

Provided is an electrode plate having improved flexibility due to slits on a side surface thereof.

Provided also is an electrode assembly including the electrode plate having the slits.

A secondary battery including the electrode assembly is also provided.

Additional aspects will be set forth in part in the description which follows and, in part, will be apparent from the description, or may be learned by practice of the presented exemplary embodiments.

According to an aspect, an electrode plate includes an electrode structure, the electrode structure including: a current collector; an electrode active material layer disposed on at least a portion of the current collector; and at least one slit which extends from a first side surface of the electrode structure to a point on a top surface of the electrode structure, wherein the at least one slit extends through the current collector and the electrode active material layer.

According to another aspect, an electrode assembly includes: a cathode plate; an anode plate; and a separator disposed between the cathode plate and the anode plate, wherein at least one of the cathode plate and the anode plate includes: an electrode structure comprising a current collector; an electrode active material layer disposed on at least a portion of the current collector; and at least one slit which extends from a first side surface of the electrode structure to a point on a top surface of the electrode structure, wherein the at least one slit extends through the current collector and the electrode active material layer.

According to yet another aspect, a secondary battery includes the electrode assembly.

Also disclosed is a method of manufacturing an electrode plate, the method including: providing a current collector; disposing an electrode active material layer on the current collector; and forming at least one slit in the current collector and the electrode active material layer to manufacture the electrode plate, wherein the at least one slit extends from a first side surface of the electrode structure to a point on a top surface of the electrode structure.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic view of an electrode plate according to an exemplary embodiment;

FIG. 2 is a schematic view of an electrode structure according to an exemplary embodiment;

FIGS. 3A to 3M are schematic views of an electrode plate including slits which extend from at least one side surface of the electrode plate, according to an exemplary embodiment;

FIG. 4 is a schematic view of a slit having a through-hole according to an exemplary embodiment;

FIG. 5 is a schematic view of a branched slit according to an exemplary embodiment;

FIG. 6 is a schematic exploded view of an electrode assembly according to an exemplary embodiment;

FIG. 7 is a schematic view of a slit included in at least one of a cathode plate and an anode plate, according to an exemplary embodiment;

FIG. 8 is a schematic exploded view of an electrode assembly according to an exemplary embodiment;

FIG. 9 is a schematic view of a secondary battery according to an exemplary embodiment;

FIGS. 10A to 10C illustrate a method of repeatedly rotating an electrode plate about a horizontal axis to measure a durability of the electrode plate;

FIG. 11A is an illustration of an anode plate and a cathode plate according to Comparative Example 1;

FIGS. 11B to 11F are illustrations of an anode plate and a cathode plate according to Examples 1 to 5, respectively;

FIG. 12A is a picture of the cathode plate according to Comparative Example 1;

FIG. 12B is a picture of the electrode plate of Example 1; and

FIG. 13 is a graph of cell discharge capacity (mAh) versus number of twists according to of Comparative Example 2, Example 6, and Example 8.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Selectively, exemplary embodiments will be described with reference to the attached drawings. In the drawings, like reference numerals denote like elements, and the sizes or thicknesses of constituting elements may be exaggerated for clarity. It will also be understood that when a material layer is referred to as being “on” a substrate or another layer, it can be directly on the substrate or the other layer or substrate, or intervening layers may also be present. Also, in the following embodiments, a material that constitutes each layer is an example only, and another material may instead be used.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, electrode plates, electrode assemblies, and secondary batteries according to exemplary embodiments will be further disclosed.

An electrode plate according to an exemplary embodiment includes: an electrode structure including: a current collector; an electrode active material layer disposed on at least a portion of the current collector; and at least one slit which extends from a first side surface of the electrode structure to a point on a top surface of the electrode structure, wherein the at least one slit extends through the current collector and the electrode active material layer.

Since the electrode plate includes the at least one slit, when the electrode plate of the secondary battery is repeatedly bent and/or twisted, the stress applied to the electrode plate may be effectively dispersed across a large area of the electrode plate rather than focused in a small area, thereby preventing an electrode from being damaged. For example, a plurality of slits introduced to an electrode plate may effectively disperse the stress which occurs due to the twisting of an electrode. Accordingly, when a secondary battery includes the electrode plate, the durability of the secondary battery may be improved.

Furthermore, when the electrode plate includes an electrode tab extending from a side surface of the electrode plate, stress focused on the electrode tab when the electrode plate is repeatedly bent and/or twisted may be suppressed thereby preventing the electrode tab from being damaged. Accordingly, when a secondary battery includes the electrode plate, the durability of the secondary battery may be improved.

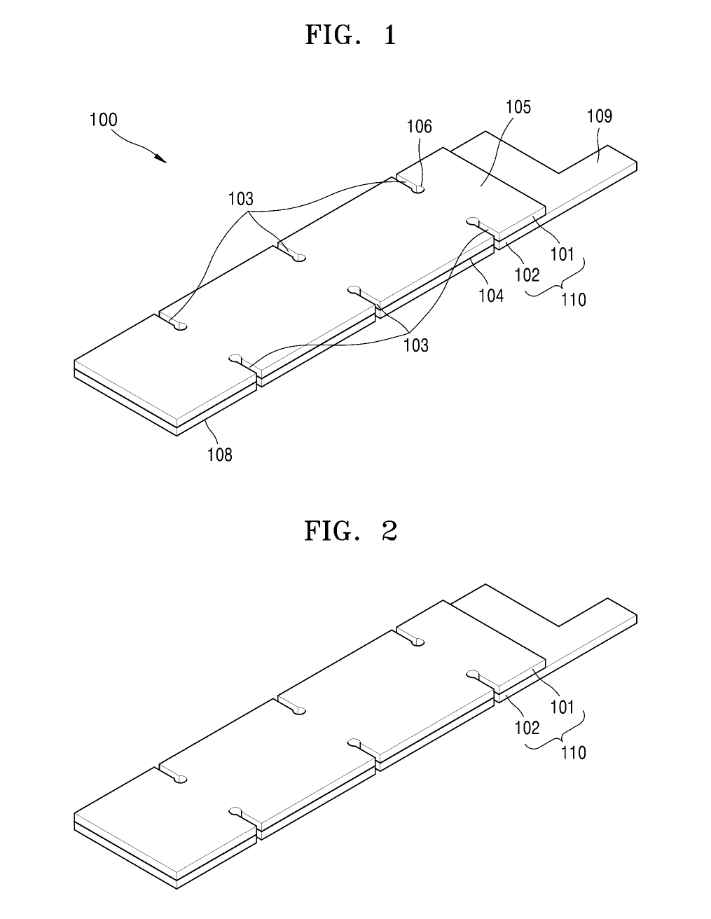

Referring to FIGS. 1 and 2, an electrode plate 100 includes: an electrode structure 110 including a current collector 102 and an electrode active material layer 101 disposed on at least a portion of the current collector 102; and at least one slit 103 extending from a first side surface 104 of the electrode structure 110 through the current collector 102 and the electrode active material layer 101 to a point 106 on a top surface 105 of the electrode structure 110. An electrode active material layer may be additionally disposed on a bottom surface 108 of the electrode structure 110, so as to be facing in a direction opposite the top surface 105 of the electrode structure 110. In some embodiments, the electrode plate 100 may include a tab 109 extending from an end surface of the current collector 102.

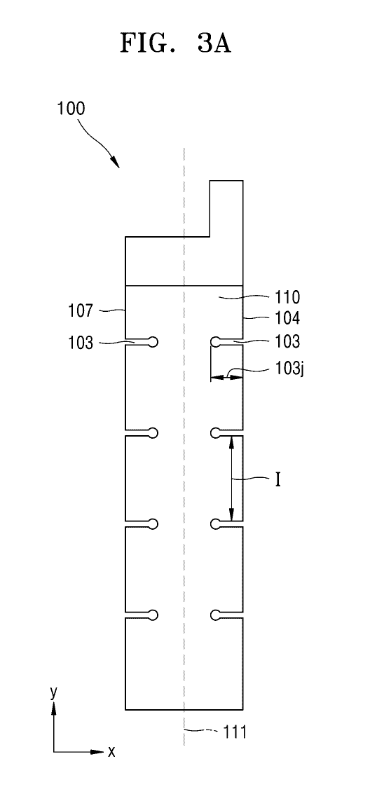

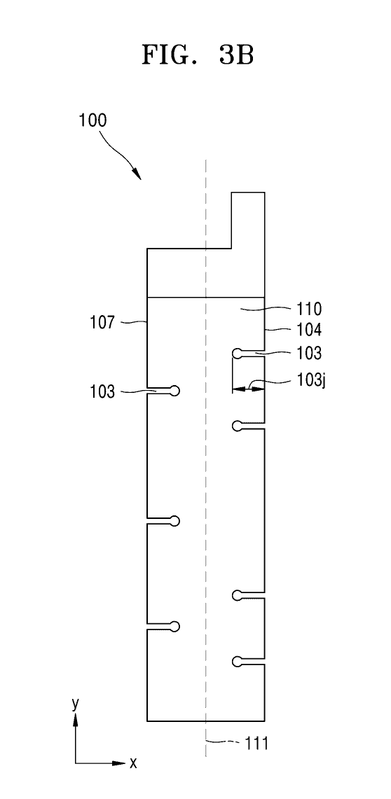

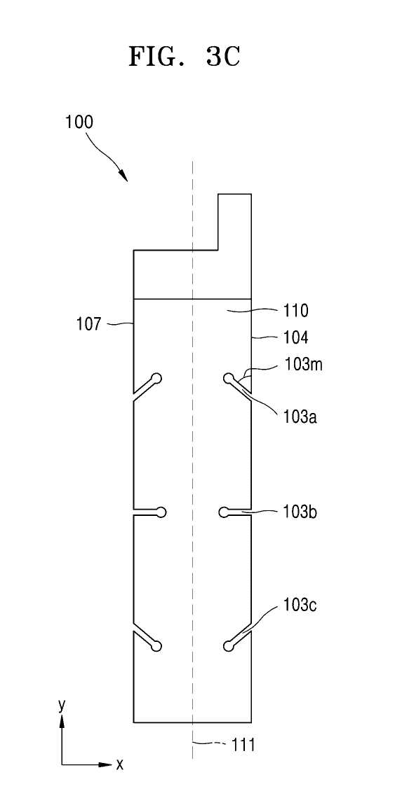

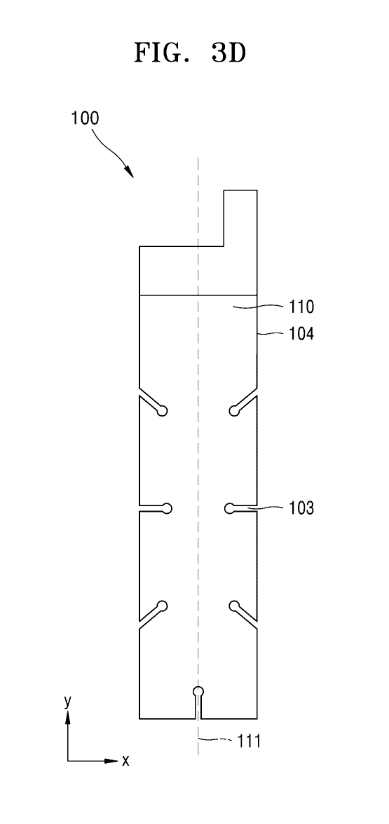

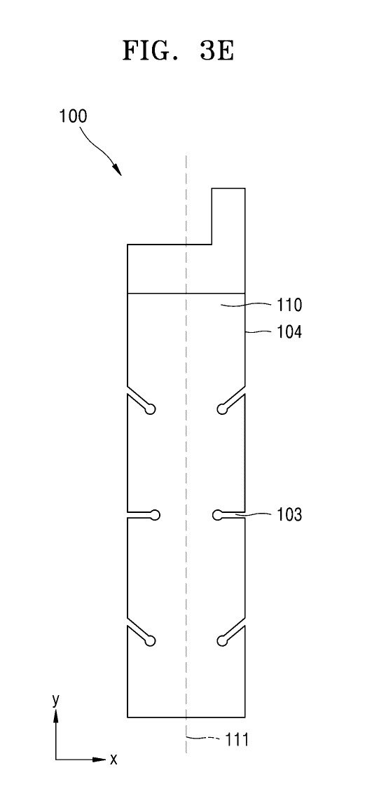

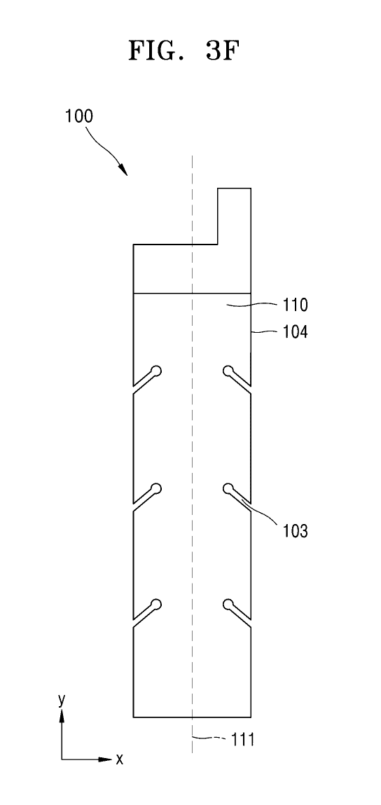

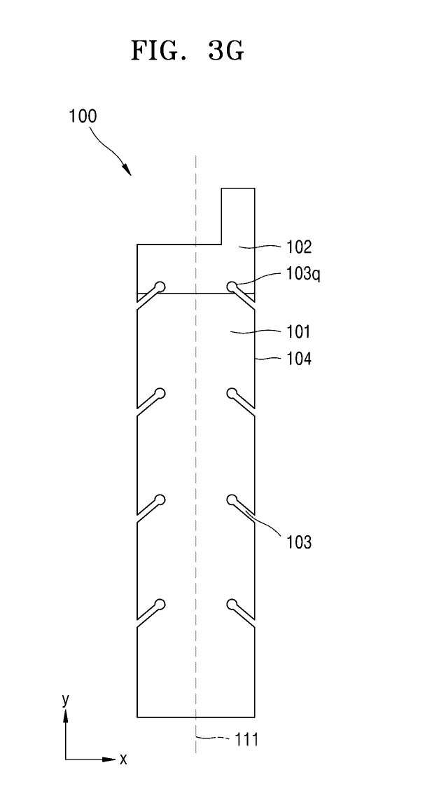

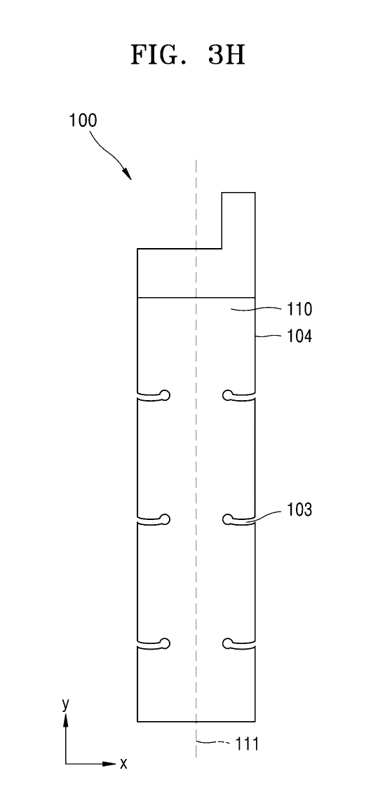

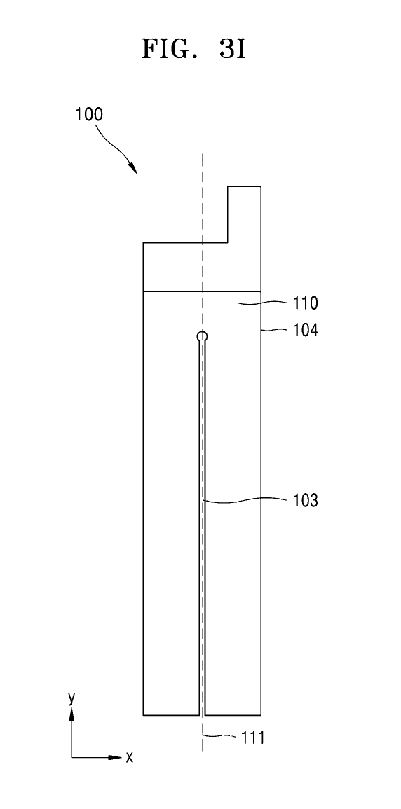

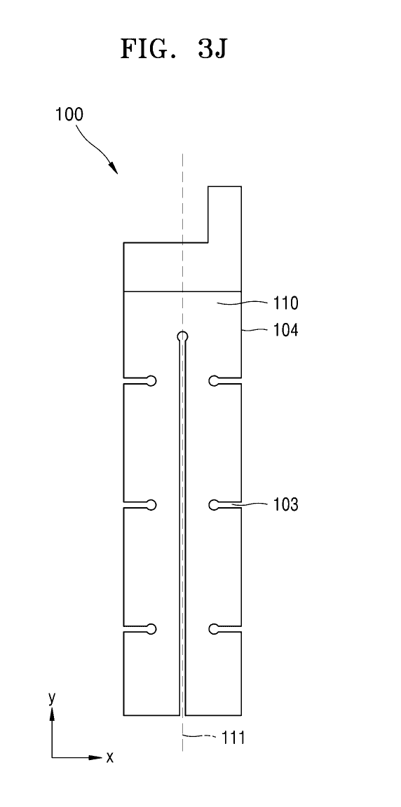

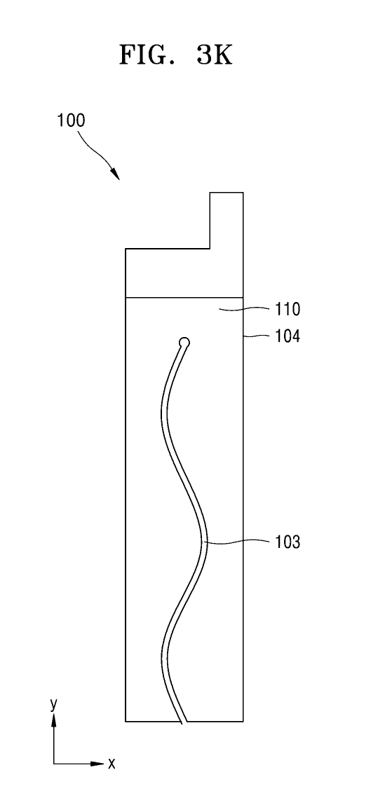

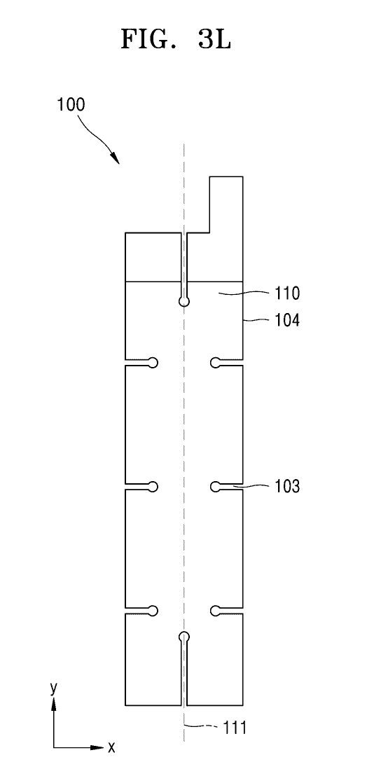

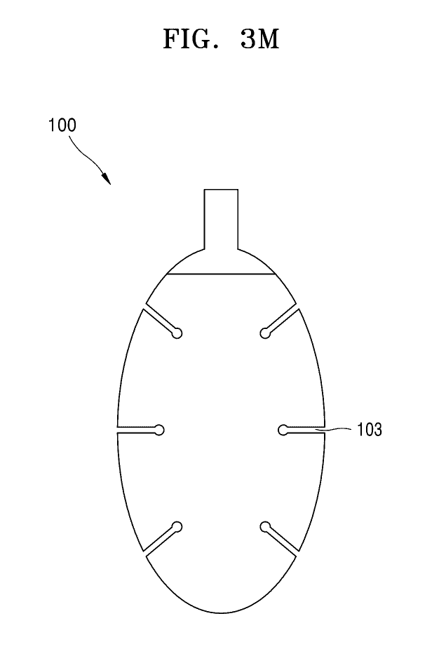

Referring to FIG. 3A, the electrode plate 100 may have two or more slits 103 spaced apart from each other at an interval I between adjacent slits and along the first side surface 104 of the electrode structure 110 and along a second side surface 107 opposite to the side surface 104. In an embodiment, the interval between each pair of adjacent slits is identical. In another embodiment, the interval between each pair of adjacent slits is independently selected. Due to the two or more slits 103 on the first and second side surfaces 104 and 107, respectively, of the electrode structure 110, the electrode plate 100 may be capable of effectively dispersing the focused stress which occurs when repeatedly bending and/or twisting the electrode plate 100, thereby preventing the electrode plate from being damaged.

Referring to FIG. 3A, the two or more slits 103 of the electrode plate 100 may be aligned along a length of the electrode plate 100. Since the slits 103 are aligned along the length of the electrode plate 100, that is, in a y-axis direction as shown in FIG. 3A, the stress which occurs when the electrode plate 100 is repeatedly twisted may be more effectively dispersed across the electrode plate.

Referring to FIG. 3A, in the electrode plate 100, the slits 103 located on the first side surface 104 of the electrode structure 110 and the slits 103 located on the second side surface 107 of the electrode structure 110 opposite the first side surface 104, are symmetrical. That is, the slits 103 may be aligned in such a way that left and right portions of the electrode plate 100 are symmetric relative to an imaginary central line 111 of the electrode plate 100 along the length of the electrode plate 100. For example, a first slit of the two or more slits which extend from the first side surface 104 of the electrode structure, and a second slit of the two or more slits which extend from the second side surface opposite the first side surface are symmetrical to each other.

In some embodiments, referring to FIG. 3B, the slits 103 of the electrode plate 100 may be aligned at different intervals along the first side surface 104 and the second side surface 107 of the electrode structure 110. That is, the slits 103 aligned along the first side surface 104 and the slits 103 aligned along the second side surface 107 of the electrode structure 110 may be spaced apart from each other at different intervals.

Referring to FIGS. 3C to 3G, the slits 103 of the electrode plate 100 may extend at an angle with respect to the first side surface 104 or the second side surface 107 of the electrode structure 110. For example, the slits may each independently form an angle of greater than 0 degrees to less than about 180 degrees with respect to the first side surface 104 or the second side surface 107 of the electrode structure 110. For example, the slits 103 of the electrode plate 100 may each independently form an angle of about 1 degree to about 179 degrees with respect to the first side surface 104 or the second side surface 107 of the electrode structure 110. For example, the slits 103 of the electrode plate 100 may each independently form an angle of about 30 degrees to about 150 degrees with respect to the first side surface 104 or the second side surface 107 of the electrode structure 110. For example, the slits 103 of the electrode plate 100 may each independently form an angle of about 45 degrees to about 135 degrees, or about 10 degrees to about 50 degrees with respect to the first side surface 104 or the second side surface 107 of the electrode structure 110. For example, the number of the slits 130 of the electrode plate 100 is two or more, and the slits 103 may each independently form at least one angle of about 45 degrees, about 90 degrees, or about 135 degrees with respect to the first side surface 104 or the second side surface 107 of the electrode structure 110. Referring to FIG. 3C, an angle 103m formed by a slit 103a and the side surface 104 of the electrode structure 110 refers to an angle formed by a straight line extending in a lengthwise direction of the slit and a straight line extending along the length of the first side surface 104 of the electrode structure 110.

Referring to FIG. 3C, regarding the electrode plate 100, an angle of the slit 103a with respect to the first side surface 104 of the electrode structure 110 may be about 20 degrees to about 60 degrees, or about 45 degrees, and an angle of the slit 103b with respect to the first side surface 104 of the electrode structure 110 may be in about 70 degrees to about 120 degrees, or about 90 degrees, or an angle of the slit 103c with respect to the first side surface 104 of the electrode structure 110 may be about 135 degrees.

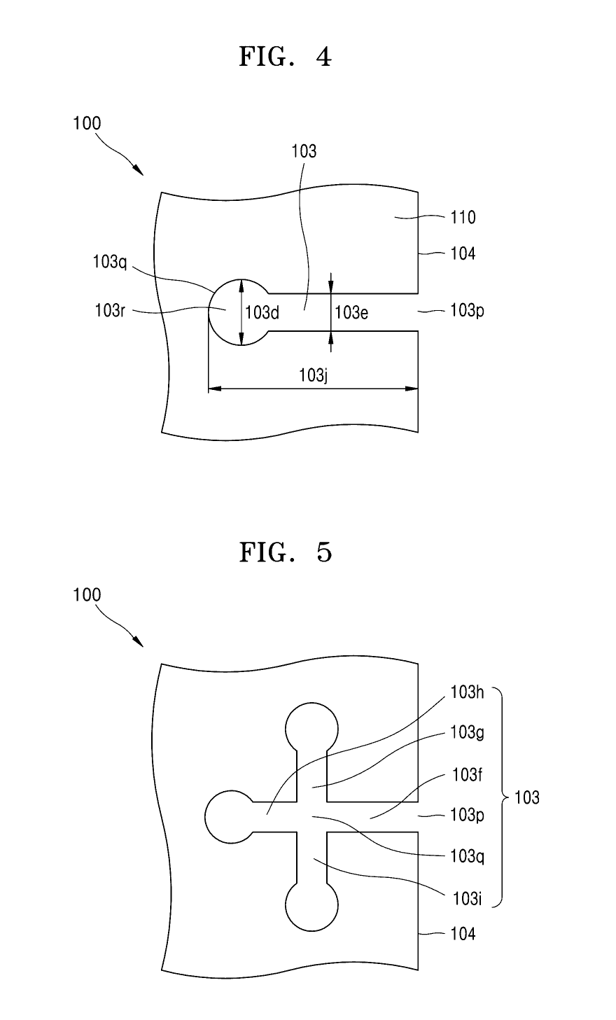

Referring to FIG. 4, the slit 103 may have an open end 103p proximate the first side surface 104 of the electrode structure 110 of the electrode plate 100. Since the open end 103p of the slit 103 opens at the first side surface 104 of the electrode structure 110, the continuity of the first side surface 104 of the electrode structure 110 is interrupted by the presence of the slit 103. Accordingly, concentrated stress which occurs when the electrode plate 100 is repeatedly twisted may be effectively dispersed across the electrode plate 100 and the overall flexibility of the electrode plate 100 may be improved.

Referring to FIG. 1, the slit 103 may have another end located at the point 106 on the top surface 105 of the electrode structure 110 of the electrode plate 100, and the other end of the slit 103 may include a through-hole. Referring to FIG. 4, the other end 103q of the slit 103 has a through-hole 103r. For example, the through-hole 103r of the other end 103q of the slit 103 may have a diameter 103d, which is greater than a width 103e of the slit 103. Since the diameter 103d of the through-hole 103r is greater than the width 103e of the slit 103, a tear propagation of the electrode plate 100, which occurs when the electrode plate 100 is twisted, may be effectively prevented.

Referring to FIG. 3G, in the electrode plate 100, at least one of the slits 103 may have an other end 103q which extends to a point on a portion of the top surface of the electrode structure 110 on which the electrode active material layer 101 is not disposed on the current collector 102. That is, the other end 103q of the slit 103 may extend to point on the top surface of the electrode structure 110 in which the current collector 102 is not coated by the electrode active material layer 101.

Referring to FIG. 5, the slit 103 of the electrode plate 100 may include a first slit 103f extending from the open end 103p at the first side surface 104 of the electrode structure 110 to the other end 103q located at a point on a top surface of an electrode assembly, and a plurality of second slits 103g, 103h, and 103i which branch from the end 103q of the first slit 103f which is distal to the first side surface 104. Thus the electrode plate 100 may include a first slit having an end at the first side surface of the electrode structure and another end at the point on the top surface of the electrode assembly, and a plurality of second slits may branch from the end of the first slit at the point on the top surface of the electrode assembly. The second slits 103g, 103h, and 103i may each independently have a width that is equal to or different from that of the first slit 103f, and may each independently have a length that is smaller than that of the first slit 103f. Each of the second slits 103g, 103h, and 103i may include an end including a through-hole. The number and shape of the plurality of second slits branched from the first slit 103f is not limited as long as the stress focused in the electrode plate 100 is effectively dispersed and the flexibility of the electrode plate 100 is improved.

Referring to FIGS. 3A and 4, in the electrode plate 100, the slit 103 may extend from the first side surface 104 to a point on the top surface of the electrode structure which is less than halfway between the first side surface 104 and the second side surface 107. Thus, a length 103j of the slit 103 may be less than half of a distance between the first side surface 104 of the electrode structure 110 and the second side surface 107 opposite the first side surface 104. Since the length 103j of the slit 103 is less than half of the width of the electrode plate 100, electrons may easily move within the electrode plate 100. In some embodiments, in consideration of the mobility of electrons and the flexibility of the electrode, the length 103j of the slit 103 may be equal to or greater than the width of the electrode plate 100.

As shown in FIGS. 3I to 3K, the slit 103 may extend from a first end surface of the electrode structure, through the current collector and the electrode active material layer, and to a point on a top surface of the electrode structure 110 which is more than halfway between the first end surface and a second end surface of the electrode structure. Thus, the length of the slit 103 may be equal to or greater than the width of the electrode plate 100.

Referring to FIGS. 3A to 3M, the length of the slit 103 of the electrode plate 100 may be straight. Alternatively, the slit 103 may be curved. However, the shape of the slit 103 is not limited, and may vary as long as the stress focused on the electrode plate 100 is effectively dispersed and the flexibility of the electrode plate 100 is improved.

Referring to FIG. 4, in the electrode plate 100, a ratio of the length 103j of the slit 103 to a width 103e of the slit 103 may be greater than or equal to 5:1, but is not limited thereto. This ratio may vary as long as the stress applied to the electrode plate 100 is effectively dispersed and the flexibility of the electrode plate 100 is improved. For example, the ratio of the length 103j of the slit 103 to the width 103e of the slit 103 may be greater than or equal to about 5:1, such as, in a range of about 5:1 to about 1000:1. For example, the ratio of the length 103j of the slit 103 to the width 103e of the slit 103 may be in a range of about 5:1 to about 100:1. For example, the ratio of the length 103j of the slit 103 to the width 103e of the slit 103 may be in a range of about 5:1 to about 50:1. For example, the ratio of the length 103j of the slit 103 to the width 103e of the slit 103 may be in a range of about 5:1 to about 25:1. For example, the ratio of the length 103j of the slit 103 to the width 103e of the slit 103 may be in a range of about 5:1 to about 10:1.

Referring to FIG. 1, the electrode plate 100 including at least one slit may have increased flexibility as compared to an electrode plate which does not include the at least one slit. The flexibility of the electrode plate 100 may be determined by repeatedly twisting the electrode plate 100 around a horizontal axis for a predetermined number of times and comparing the effect of the twisting on the structural integrity and function of the electrode plate 100, to the effect of the twisting on the structure and function of an electrode plate which does not include the at least one slit. Due to the increased flexibility, the electrode plate 100 may effectively disperse stress focused when twisting repeatedly occurs.

Referring to FIGS. 1 to 5, the electrode active material layer 101 of the electrode plate 100 may include an electrode active material. The electrode active material layer may further include at least one of a conductive material, a binder, or a plasticizer.

The electrode active material layer 101 may include a cathode active material. The cathode active material is not limited, and may be any cathode active material that is used in the art for a secondary battery. The cathode active material may be a lithium-containing metal oxide.

For example, the cathode active material may include a composite oxide that includes lithium and a metal selected from cobalt, manganese, nickel, or a combination thereof. Examples of the composite oxide include compounds represented by LiₐA_{1-b}B′_{b}D₂ (wherein 0.90≦a≦1, and 0≦b≦0.5); LiₐE_{1-b}B′_{b}O_{2-c}D_{c} (wherein 0.90≦a≦1, 0≦b≦0.5, and 0≦c≦0.05); LiE_{2-b}B′_{b}O_{4-c}D_{c} (wherein 0≦b≦0.5, and 0≦c≦0.05); LiₐNi_{1-b-c}Co_{b}B′_{c}D_{α} (wherein 0.90≦a≦1, 0≦b≦0.5, 0≦c≦0.05, and 0<α<2); LiₐNi_{1-b-c}Co_{b}B′_{c}O_{2-α}F_{α} (wherein 0.90≦a≦1, 0≦b≦0.5, 0≦c≦0.05, and 0<α<2); LiₐNi_{1-b-c}Co_{b}B′_{c}O_{2-α}F₂ (wherein 0.90≦a≦1, 0≦b≦0.5, 0≦c≦0.05, and 0<α<2); LiₐNi_{1-b-c}Mn_{b}B′_{c}D_{α} (wherein 0.90≦a≦1, 0≦b≦0.5, 0≦c≦0.05, and 0<α<2); LiₐNi_{1-b-c}Mn_{b}B′_{c}O_{2-α}F′_{α} (wherein 0.90≦a≦1, 0≦b≦0.5, 0≦c≦0.05, and 0<α<2); LiₐNi_{1-b-c}Mn_{b}B′_{c}O_{2-α}F′₂ (wherein 0.90≦a≦1, 0≦b≦0.5, 0≦c≦0.05, and 0<α<2); LiₐNi_{b}E_{c}G_{d}O₂ (wherein 0.90≦a≦1, 0≦b≦0.9, 0≦c≦0.5, and 0.001≦d≦0.1.); LiₐNi_{b}Co_{c}Mn_{d}GeO₂ (wherein 0.90≦a≦1, 0≦b≦0.9, 0≦c≦0.5, 0≦d≦0.5, and 0.001≦e≦0.1.); LiₐNiG_{b}O₂ (wherein 0.90≦a≦1, and 0.001≦b≦0.1.); LiₐCoG_{b}O₂ (wherein 0.90≦a≦1, and 0.001≦b≦0.1.); LiₐMnG_{b}O₂ (wherein 0.90≦a≦1, and 0.001≦b≦0.1.); LiₐMn₂G_{b}O₄ (wherein 0.90≦a≦1, and 0.001≦b≦0.1.); QO₂; QS₂; LiQS₂; V₂O₅; LiV₂O₅; LiI′O₂; LiNiVO₄; Li_{(3-f)}J₂(PO₄)₃(0≦f≦2); Li_{(3-f)}Fe₂(PO₄)₃(0≦f≦2); and LiFePO₄.

In the formulae above, A is Ni, Co, Mn, or a combination thereof; B′ is Al, Ni, Co, Mn, Cr, Fe, Mg, Sr, V, a rare-earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof.

The cathode active materials represented by the formulae above may further include a coating layer on their surfaces. The coating layer may include a coating element comprising Mg, Al, Co, K, Na, Ca, Si, Ti, V, Sn, Ge, Ga, B, As, Zr, or a combination thereof. The coating layer may include an oxide of the coating element, a hydroxide of the coating element, an oxyhydroxide of the coating element, an oxycarbonate of the coating element, or a hydroxycarbonate of the coating element. The coating element compounds constituting the coating layers may be amorphous or crystalline. In some embodiments, the electrode active material layer 101 may include a cathode active material that is represented by one of the formulae above and which does not include a coating layer thereon, a cathode active material that is represented by one of the formulae above and includes a coating layer thereon, or a combination thereof.

The electrode active material layer 101 may include, for example, at least one cathode active material selected from LiNiO₂, LiCoO₂, LiMnₓO₂ₓ(x=1, 2), LiNi₁₋ₓMnₓO₂(0<x<1), LiNi_{1-x-y}CoₓMn_{y}O₂(0≦x≦0.5, 0≦y≦0.5), LiFePO₄, LiFeO₂, V₂O₅, TiS, and MoS.

In some embodiments, the electrode active material layer 101 may include an anode active material. The anode active material may be any anode active material that is used in the art for a secondary battery. The anode active material may comprise lithium metal, a lithium-alloyable metal, a transition metal oxide, a non-transition metal oxide, a carbonaceous material, or a combination thereof.

For example, the lithium-alloyable metal may be Si, Sn, Al, Ge, Pb, Bi, Sb, Si—Y alloy (where Y′ is an alkali metal, alkaline earth metal, a Group 13 element, a Group 14 element, transition metal, rare earth element, or a combination thereof and is not Si), or Sn—Y″ alloy (where Y″ is an alkali metal, alkaline earth metal, a Group 13 element, a Group 14 element, transition metal, rare earth element, or a combination thereof element and is not Sn). The elements Y′ and Y″ may each independently be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

For example, the transition metal oxide may be a lithium titanium oxide, a vanadium oxide, a lithium vanadium oxide, or the like.

For example, the non-transition metal oxide may be SnO₂, SiOₓ(0<x<2), or the like.

For example, the carbonaceous material may be a crystalline carbon, an amorphous carbon, or a mixture thereof. The crystalline carbon may be natural or artificial graphite, and the amorphous carbon may be soft carbon (cold calcined carbon) or hard carbon, meso-phase pitch carbide, calcined cork, or the like. The natural artificial graphite may not have a defined shape or alternatively, may have a tubular, flake, spherical, or fibrous shape.

The electrode active material layer 101 may include a conductive material. Examples of the conductive material are carbon black, particulate graphite, natural graphite, artificial graphite, acetylene black, ketjen black, carbon fiber, carbon nanotubes, metal powder, metal fiber or metal tubes, such as copper, nickel, aluminum, or silver; and a conductive polymer, such as polyphenylene derivative. However, the conductive material is not limited thereto and may be any suitable conductive material.

The electrode active material layer 101 may include a binder. Examples of the binder are a vinylidene fluoride/hexafluoropropylene copolymer, polyvinylidene fluoride (PVDF), polyacrylonitrile, poly(methylmethacrylate) (PMMA), polytetrafluoroethylene (PTFE), a mixture thereof, and a styrene butadiene rubber-based polymer.

An electrode assembly according to another aspect includes a cathode plate; an anode plate; and a separator between the cathode plate and the anode plate, and at least one of the cathode plate and the anode plate may be the electrode plate described above.

Since the electrode assembly includes at least one of the cathode plate having slits and the anode plate having slits, the stress focused on the electrode assembly which occurs due to repeated twisting, may be effectively dispersed.

Referring to FIG. 6, an electrode assembly 200 includes a cathode plate 100a, an anode plate 100b, and a separator 120 between the cathode plate 100a and the anode plate 100b, and at least one of the cathode plate 100a and the anode plate 100b may be the electrode plate 100 described above.

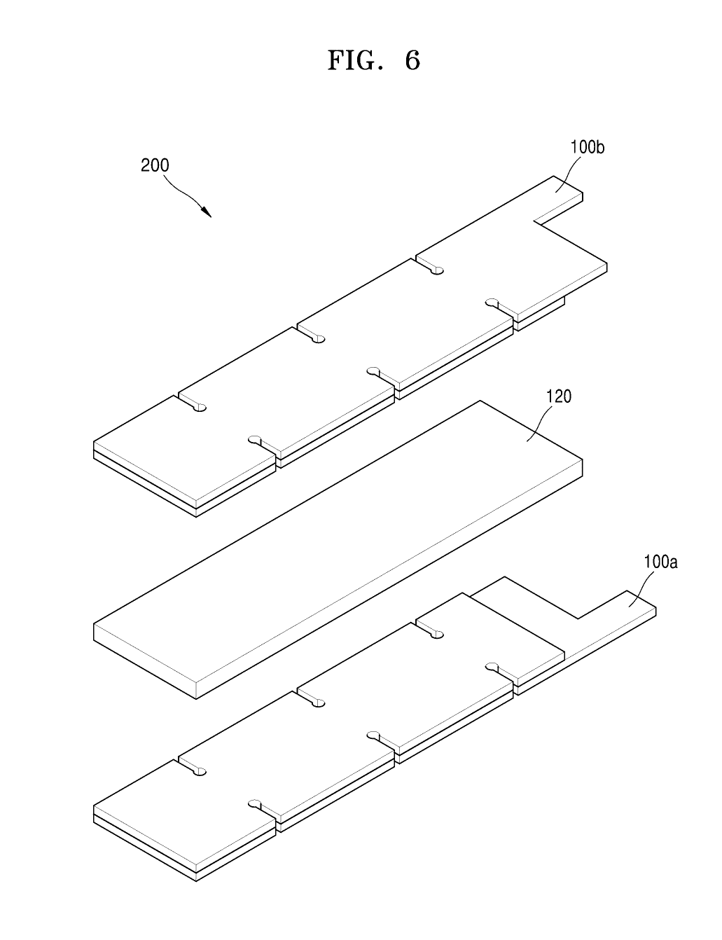

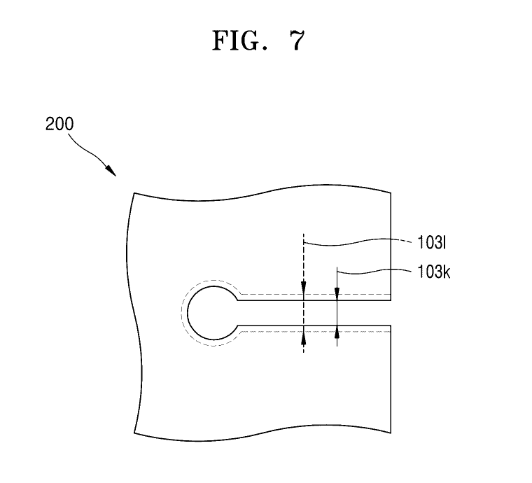

Referring to FIG. 7, in the electrode assembly 200, a width 103k of a slit in an anode plate may be equal to or smaller than a width 103l of a slit in a cathode plate. Since in the electrode assembly 200, the width 103k of the slit in the anode plate is equal to or smaller than the width 103l of the slit in the cathode plate, an area of an anode active material layer of the anode plate is equal to or greater than an area of a cathode active material layer of the cathode plate. Accordingly, the negative-to-positive capacity (N/P) ratio may be greater than or equal to 1.

Referring to FIG. 8, in the electrode assembly 200, the separator 120 may also include at least one slit 103. The pattern of the slit 103 in the separator may be the same pattern as a slit of at least one of the cathode plate 100a or the anode plate 100b. Since the slit 103 of the separator 120 has the same pattern as those of the cathode plate 100a and the anode plate 100b, the stress applied when the electrode assembly 200 is repeatedly twisted, may be effectively dispersed.

In an embodiment, a method of manufacturing an electrode plate comprises providing a current collector; disposing an electrode active material layer on the current collector; and forming at least one slit in the current collector and the electrode active material layer to manufacture the electrode plate, wherein the at least one slit extends from a first side surface of the electrode structure to a point on a top surface of the electrode structure. The slit be formed by any suitable method, such as by cutting with a die, the details of which can be determined by one of skill in the art without undue experimentation.

Referring to FIGS. 6 to 8, the electrode assembly 200 may be prepared as follows.

A process for preparing the cathode plate 100a will now be further described. A cathode active material, a conductive material, a binder, and a solvent are mixed to prepare a cathode active material composition. The cathode active material composition is directly coated on an aluminum current collector and dried to form the cathode plate 100a including a cathode active material layer. In other embodiments, the cathode active material composition is cast on a separate support, and then a film exfoliated from the support is laminated on the aluminum current collector to prepare the cathode plate 100a including a cathode active material layer.

The cathode active material, the conductive material, and the binder used in preparing the cathode plate 100a may be the same as explained in connection with the electrode plate described above. As a solvent available for the preparation of the cathode plate 100a, N-methylpyrrolidone (NMP), acetone, water, or the like may be used. However, the solvent is not limited thereto, and may be any of various materials that are available in the art. In some cases, a plasticizer may be added to the cathode active material composition to form pores in the cathode plate 100a.

The amounts of the cathode active material, the conductive material, the binder, and the solvent used in preparing the cathode plate 100a are at the same levels as typically used in a secondary battery. According to the purpose and structure of a secondary battery, at least one of the conductive material, the binder, and the solvent may not be used. The secondary battery may be a lithium battery.

A process for preparing the anode plate 100b will now be explained. The anode plate 100b may be prepared in the same manner as used to prepare the cathode plate 100a, except that an anode active material is used instead of the cathode active material. The conductive material, the binder, and the solvent of the anode active material composition may be the same as used to prepare the cathode plate 100a.

For example, the anode active material, the conductive material, the binder, and the solvent are mixed to prepare an anode active material composition, which is then directly coated on a copper current collector to complete the preparation of the anode plate 100b. In some embodiments, the anode active material composition is cast on a separate support, and an anode active material film exfoliated from the support is laminated on the copper current collector, thereby completing the preparation of the anode plate 100b. The amounts of the anode active material, the conductive material, the binder, and the solvent used in preparing the anode plate 100b are at the same levels as typically used in a secondary battery.

Then, the separator 120 to be inserted between the cathode plate 100a and the anode plate 100b is prepared. The separator 120 may be any separator that is typically used in a secondary battery, such as a lithium battery. A material for forming the separator may be a material that has a low resistance to ion migration of an electrolyte and has excellent electrolytic solution retaining capability. For example, the separator forming material may be selected from glass fiber, polyester, Teflon, polyethylene, polypropylene, polytetrafluoroethylene (PTFE), and a combination thereof, each of which may be in a non-woven fabric or woven fabric form. For example, a separator for a lithium ion battery may be a rollable separator formed of polyethylene or polypropylene. The separator for a lithium ion polymer battery may be a separator having excellent organic electrolyte-retaining capabilities.

For example, the separator 120 may be prepared by the following method. For example, a separator composition is prepared by mixing a polymer resin, a filler, and a solvent. The separator composition may be directly coated on a cathode plate or an anode plate to form the separator 120. In some embodiments, the separator composition may be cast and dried on a support, and a separator film exfoliated from the support is laminated on an electrode to complete the preparation of the separator 120.

A polymer resin used in preparing the separator 120 may not be particularly limited, and any material that is used as a binder for a cathode plate or an anode plate may be used. Examples of the polymer resin are a vinylidenefluoride/hexafluoropropylene copolymer, polyvinylidene fluoride (PVDF), polyacrylonitrile, poly(methylmethacrylate) (PMMA), and a mixture thereof, but are not limited thereto. The separator forming material may be any material that is used in preparing a separator in the art.

The separator 200 is located between the cathode plate 100a and the anode plate 100b, thereby completing the preparation of the electrode assembly 200.

A secondary battery according to another aspect includes the electrode assembly described above.

Since the secondary battery includes the electrode assembly, stress which would otherwise be focused when the secondary battery is repeatedly twisted may be effectively dispersed. As a result, the durability of the secondary battery may be improved and ultimately, lifetime characteristics of the secondary battery may also be improved.

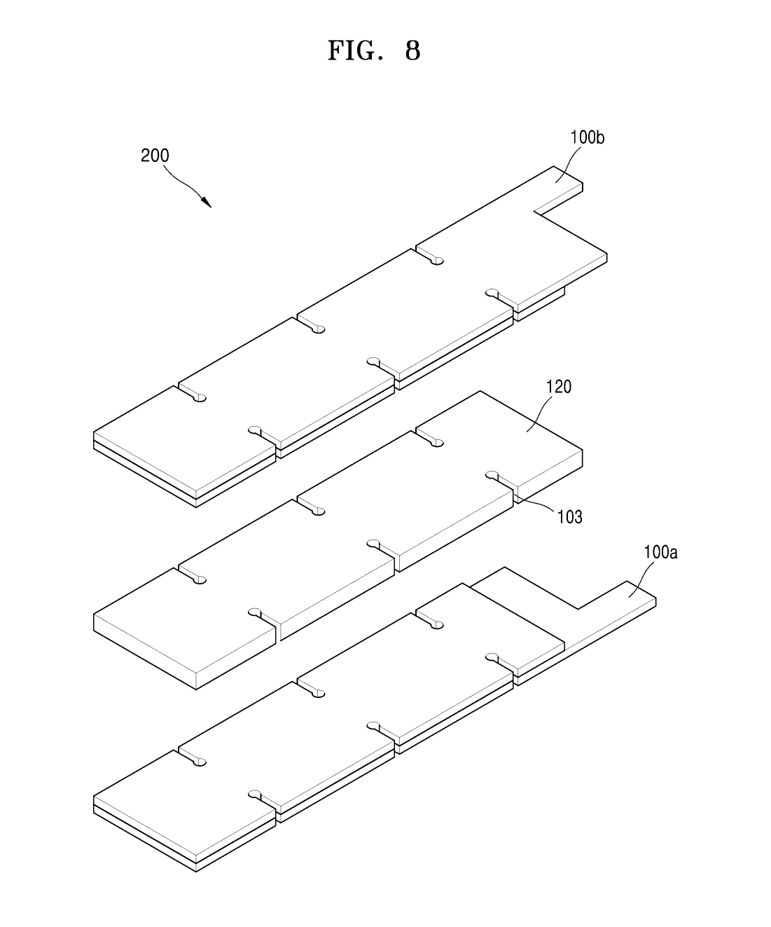

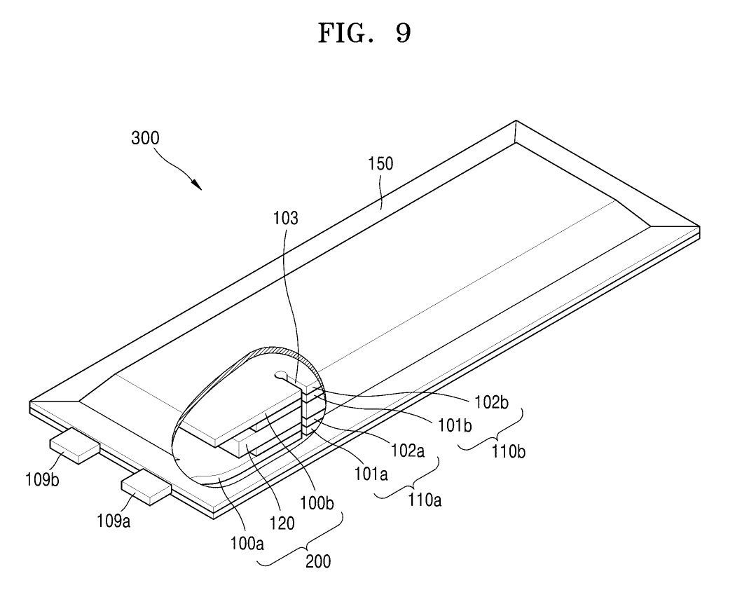

Referring to FIG. 9, a secondary battery 300 includes the electrode assembly 200. For example, the secondary battery 300 includes: the electrode assembly 200 including the cathode plate 100a, the anode plate 100b, and the separator 120 between the cathode plate 100a and the anode plate 100b, and a pouch 150 sealing the electrode assembly 200. The electrode assembly 200 may be impregnated with an electrolytic solution. A cathode tab 109a extending from the cathode plate 100a and an anode tab 109b extending from the anode plate 100b may be exposed outside of the pouch 105. The cathode plate 100a includes a cathode structure 110a including a cathode active material layer 101a and a cathode current collector 102a, and the anode plate 100b includes an anode structure 110b including an anode active material layer 101b and an anode current collector 102b. The electrode assembly 200 includes the slits 103 in the cathode plate 100a, the anode plate 100b, and the separator 102. In some embodiments, the slits 103 may not be included in the separator 120.

Referring to FIG. 9, a process for manufacturing the secondary battery 300 will now be described in detail. For example, the secondary battery may be a lithium battery.

First, the electrode assembly 200 is prepared in the same manner as described above.

Next, an electrolyte is prepared. For example, the electrolyte may be an organic electrolytic solution. In some embodiments, the electrolyte may be a solid electrolyte. The solid electrolyte may be boron oxide, lithium oxynitride, or the like, but is not limited thereto. The solid electrolyte may be any material that is used as a solid electrolyte in the art. The solid electrolyte may be formed on the electrode plate or separator by, for example, sputtering.

For example, an organic electrolytic solution may be prepared as the electrolyte. The organic electrolytic solution may be prepared by dissolving a lithium salt in an organic solvent.

Examples of the organic solvent are propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxirane, 4-methyldioxirane, N,N-dimethylformamide, dimethylacetamide, dimethylsulfoxide, dioxane, 1,2-dimethoxyethane, sulfolane, dichloroethane, chlorobenzene, nitrobenzene, diethylene glycol, dimethyl ether, and a mixture thereof, but are not limited thereto. The organic solvent may be any material that is used as an organic solvent for an organic electrolytic solution in the art.

Examples of the lithium salt include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where each of x and y is a natural number), LiCl, lithium bis(trifluoromethane sulfonyl)imide (Lilm), and a mixture thereof, but are not limited thereto. The lithium salt may be any suitable material that is used as a lithium salt in the art.

Referring to FIG. 9, the secondary battery 300 includes the electrode assembly 200 including the cathode plate 100a, the anode plate 100b, and the separator 120. The electrode assembly 200 is impregnated with an organic electrolytic solution, and the electrode assembly 200 impregnated with the organic electrolytic solution is placed in the pouch 150, followed by sealing of the pouch. The electrode assembly 200 may include multiple electrode assemblies, and the electrode assemblies may be stacked together before being placed into the pouch 150. The secondary battery 300 may include multiple secondary batteries, and the secondary batteries may be stacked together to form a battery pack. The battery pack may be used in various devices requiring a flexible secondary battery. The type of pouch 150 is not limited as long as has flexibility, and is capable of separating the electrode assembly 200 from the external environment, and not allowing, for example, external air and an electrolyte to permeate therethrough. The pouch 150 may have, for example, a laminate structure including one or more layers. The one or more-layer laminate structure may include, for example, a single-layered structure of a polymer layer, a two-layered structure of first polymer layer/second polymer layer, or a third-layered structure of first polymer layer/metal foil layer/second polymer layer. However, the one or more-layer laminate structure is not limited, and may be any structure that is available in the art. The metal foil includes metal selected from aluminum, tin, copper, stainless steel, and the like, but the metal is not limited thereto. The metal foil may be any material that is substantially non-permeable and typically used as a metal foil in the art. A material for at least one layer of the first polymer layer and the second polymer layer may be a polymer, such as polyethylene (PE), polypropylene (PP), polytetrafluoroethylene (PTFE), polyisobutylene (PB), or the like. However, the material for at least one layer of the first polymer layer and the second polymer layer is not limited to these materials. For example, the material for at least one layer of the first polymer layer and the second polymer layer may be any polymer that is resistant to chemicals and forms a stable laminate composite layer together with metal foil.

The secondary battery 300 may be used in, for example, a wearable device, such as a smart watch. The secondary battery 300 may be an alkali metal battery. For example, the secondary battery may be a lithium secondary battery or a sodium secondary battery.

Embodiments of the inventive concept will be described with reference to Examples and Comparative Examples below. However, the Examples are provided here for illustrative purpose only, and are not intended to limit the scope of the inventive concept.

### EXAMPLES

### (Manufacture of Electrode Plate)

### Example 1

### (Manufacture of Anode Plate)

An artificial graphite-natural graphite mixture, a styrene-butadiene rubber (SBR) binder, and carboxymethyl cellulose (CMC, Sunrose Co.) were mixed at a weight ratio of 97.5:1.5:1, and then the mixture was added to distilled water and stirred to prepare an anode active material slurry. The anode active material slurry was coated on a copper current collector having a thickness of 10 micrometers (μm), and dried at a temperature of 80° C. for 0.5 hours, and then dried at a temperature of 120° C. for 4 hours. The result was roll-pressed to complete the manufacture of an anode plate including the copper current collector and an anode active material layer disposed thereon.

Subsequently, opposite sides of the anode plate were cut to form slits therein using a laser cutter.

### (Manufacture of Cathode Plate)

A LiCoO₂ cathode active material, a carbon conductive agent, and a polyvinylidene fluoride (PVDF) binder were mixed at a weight ratio of 97.6:1.3:1.1, and the mixture was mixed with N-methylpyrrolidone (NMP) to prepare a cathode active material slurry. The cathode active material slurry was coated on an aluminum current collector having a thickness of 15 μm, and dried at a temperature of 80° C., and vacuum-dried at a temperature of 120° C. for 4 hours. The result was roll-pressed to complete the manufacture of a cathode plate including the aluminum current collector and a cathode active material layer disposed thereon.

Subsequently, opposite sides of the cathode plate were cut to form slits therein using a laser cutter.

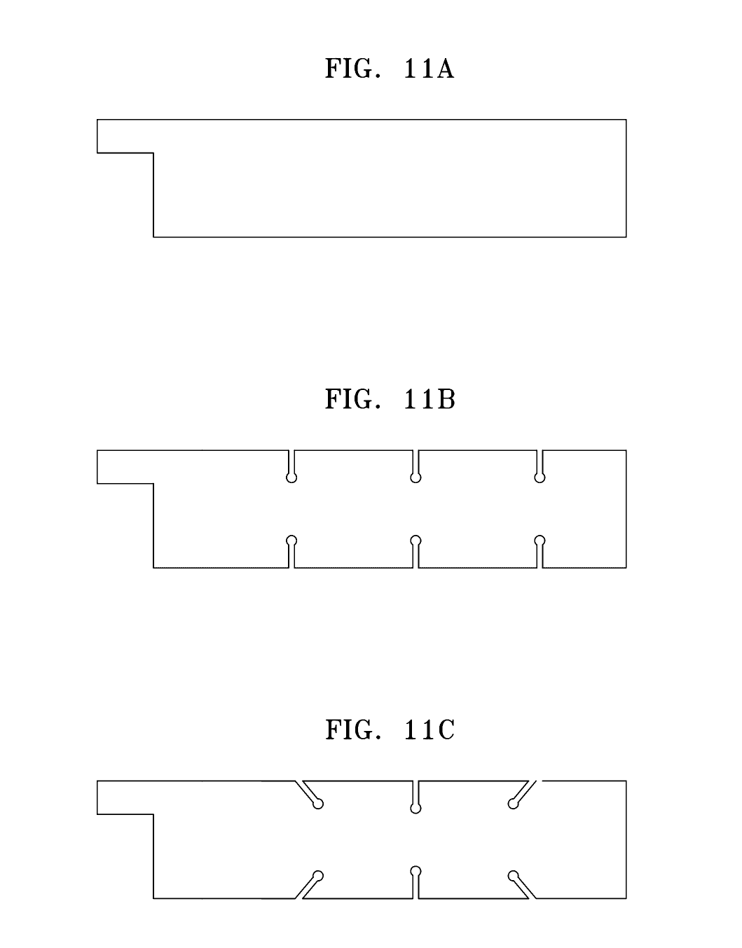

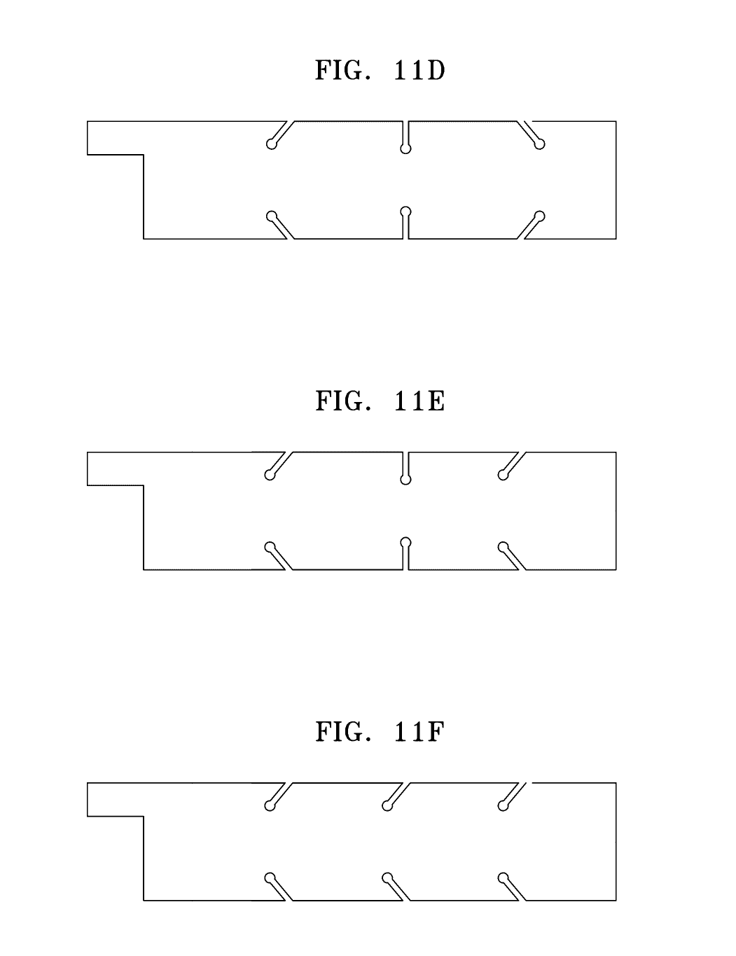

Slits formed in the anode plate and the cathode plate are illustrated in FIG. 11B.

### Examples 2 to 5

Cathode plates and anode plates were manufactured in the same manner as in Example 1, except that slits formed in the anode plates and the cathode plates had the shapes illustrated in FIGS. 11C to 11F, respectively.

### Comparative Example 1

A cathode plate and an anode plate were manufactured in the same manner as in Example 1, except that slits were not formed. The anode plate and the cathode plate, each not having slits, are illustrated in FIG. 11A.

### (Manufacture of Electrode Assembly and Lithium Battery)

### Example 6

A separator was positioned between the cathode plate and anode plate prepared according to Example 1 to prepare an electrode assembly. The electrode assembly was placed in a pouch, and an electrolytic solution was provided thereto. Then, the pouch was sealed to complete the manufacture of a lithium battery. The lithium battery was a pouch cell having a width of 26 mm and a length of 110 mm.

The separator was a polyethylene-polypropylene copolymer separator having a thickness of 14 μm.

The electrolytic solution was prepared by dissolving 1.15 molar (M) LiPF₆ in a mixed solvent including ethylene carbonate (EC), diethyl carbonate (DEC), and ethylmethyl carbonate (EMC) at a volumetric ratio of 3:2:5.

### Examples 7 to 10

Lithium batteries were manufactured in the same manner as in Example 6, except that the cathode plates and anode plates prepared according to Examples 2 to 5 were used instead of the cathode plate and anode plate prepared according to Example 1.

### Comparative Example 2

A lithium battery was manufactured in the same manner as in Example 2, except that the cathode plate and anode plate prepared according to Comparative Example 1 was used.

### Evaluation Example 1

### Evaluation for Twisting of Electrode Plate

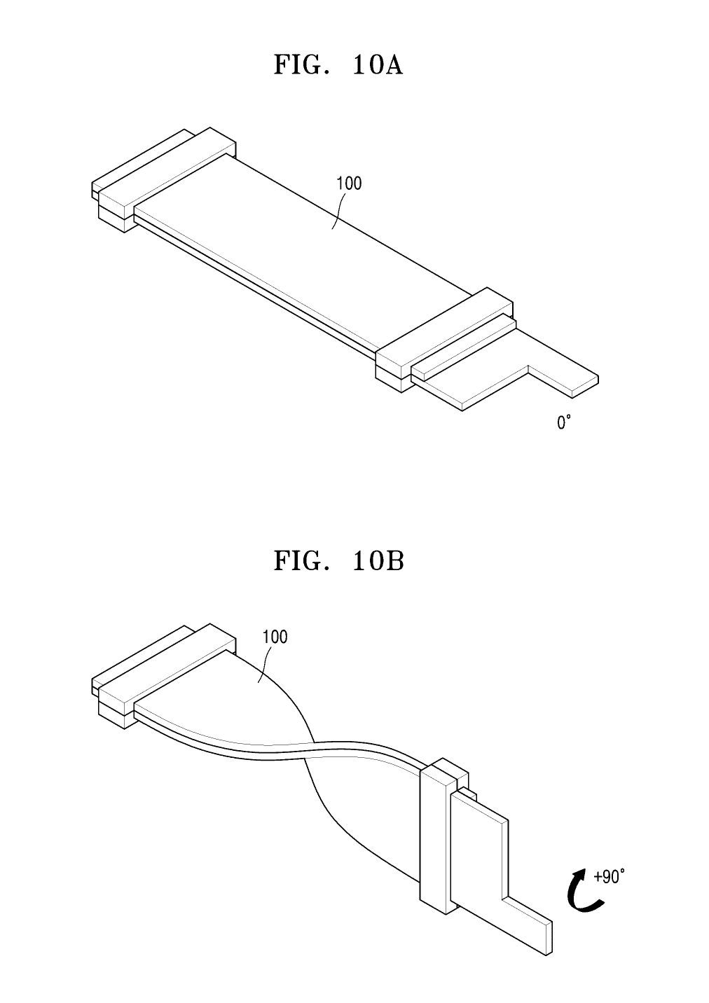

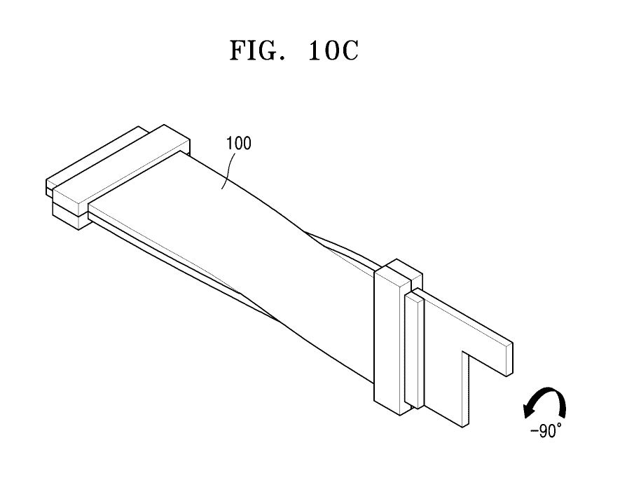

Referring to FIGS. 10A to 10C, regarding each of the cathode and anode plates prepared according to Examples 1 to 5 and Comparative Example 1, the ends of an electrode plate were horizontally grasped by a self-made twisting device, and then, one of the ends was repeatedly, alternately rotated by +90 degrees and −90 degrees about a horizontal axis while the other end of the electrode plate was held in a fixed position, in order to evaluate durability thereof against twisting.

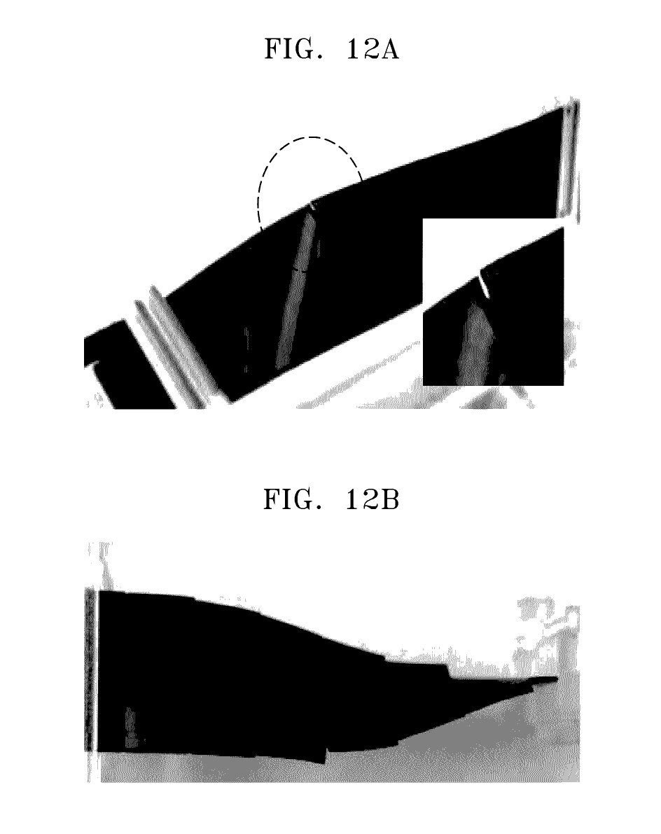

Referring to FIGS. 12A and 12B, after 50 times of twisting, the cathode plate of Comparative Example 1 (FIG. 12A) was torn, and the electrode plate of Example 1 (FIG. 12B) was not torn.

### Evaluation Example 2

### Charge and Discharge Test

The lithium batteries manufactured according to Examples 6 to 10 and Comparative Example 2 were horizontally grasped by a self-made twisting device, and then, one end of each of the lithium batteries was repeatedly, alternately rotated 2000 times by +75 degrees and −75 degrees about a horizontal axis, while holding the other end of the lithium battery in a fixed position, in order to evaluate durability thereof against twisting.

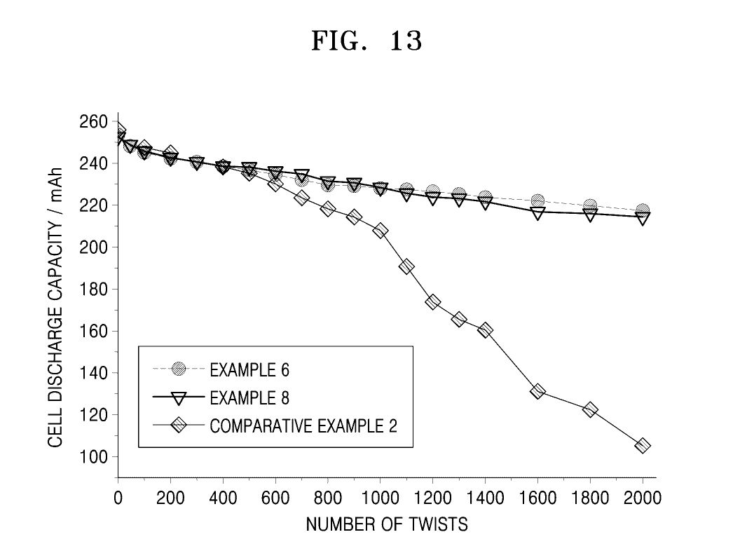

Regarding the pouch cells manufactured according to Examples 6 to 10 and Comparative Example 2, after twisting had been performed 100 times, the pouch cells were charged and discharged with a constant current of 0.1 C, at a temperature of 25° C., and a voltage range of 3.0 to 4.35 V with respect to lithium metal, to measure a discharge capacity. The results are shown in Table 1 and FIG. 13. The pouch cells were designed to have a discharge capacity of 260 milliampere hours (mAh). The discharge capacity retention ratio is defined according to Equation 1.

Discharge capacity retention ratio [%]=[discharge capacity after n times of twisting/discharge capacity before twisting]×100% Equation 1:

TABLE 1

| | Discharge capacity retention ratio [%] | | |
|---|---|---|---|
| | Comparative | | |
| Number of Twists | Example 2 | Example 6 | Example 8 |
| 500 | 91.73 | 93.58 | 94.23 |
| 1000 | 81.22 | 90.09 | 90.60 |
| 2000 | 41.04 | 85.87 | 85.04 |

Referring to Table 1 and FIG. 13, the lithium batteries having slits of Examples 6 and 8 had higher discharge capacity retention ratios and higher durability than the slit-less lithium battery of Comparative Example 2. This result may be due to the ability of the slits to mitigate the damage to an electrode which occurs when stress is focused on the electrode during twisting.

According to the exemplary embodiments described above, due to the use of an electrode plate having slits, durability of a lithium secondary battery may be improved.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An electrode plate comprising an electrode structure, the electrode structure comprising:
a current collector;
an electrode active material layer disposed on at least a portion of the current collector; and
at least one slit which extends from a first side surface of the electrode structure to a point on a top surface of the electrode structure,
wherein the at least one slit extends through the current collector and the electrode active material layer.

2. The electrode plate of claim 1, wherein the electrode structure comprises two or more slits, and
wherein the slits of the two or more slits are spaced apart from each other at an identical interval along the first side surface of the electrode structure and along a second side surface of the electrode structure, which is opposite the first side surface.

3. The electrode plate of claim 2, wherein the two or more slits are aligned in a lengthwise direction of the electrode plate or widthwise direction of the electrode plate.

4. The electrode plate of claim 2, wherein a first slit of the two or more slits, which extends from the first side surface of the electrode structure, and a second slit of the two or more slits, which extends from the second side surface of the electrode structure opposite the first side surface, are symmetrical.

5. The electrode plate of claim 1, wherein the electrode plate comprises two or more slits, and
wherein the two or more slits are spaced apart from each other at different intervals along the first side surface of the electrode structure and along a second side surface opposite to the first side surface.

6. The electrode plate of claim 1, wherein the at least one slit forms an angle of greater than 0 degrees to less than 180 degrees with respect to the first side surface of the electrode structure.

7. The electrode plate of claim 1, wherein the at least one slit forms an angle of 45 degrees to 90 degrees with respect to the first side surface of the electrode structure.

8. The electrode plate of claim 1, wherein the electrode plate comprises two or more slits, and
wherein the two or more slits form an identical angle with respect to the first side surface of the electrode structure.

9. The electrode plate of claim 1, wherein the at least one slit has an open end which contacts the first side surface of the electrode structure.

10. The electrode plate of claim 1, wherein the at least one slit has an end located at the point on the top surface of the electrode structure, and
wherein the end comprises a through-hole.

11. The electrode plate of claim 10, wherein a diameter of the through-hole is greater than a width of the slit.

12. The electrode plate of claim 1, wherein the at least one slit has an end which extends to a point on the top surface of the electrode structure where the electrode active material layer is not disposed on the current collector.

13. The electrode plate of claim 1, wherein the at least one slit comprises:
a first slit extending from the first side surface of the electrode structure to the point on the top surface of the electrode structure, and
a plurality of second slits branching from an end of the first slit which is at the point on the top surface of the electrode structure.

14. The electrode plate of claim 1, wherein a length of the at least one slit is less than one-half of a distance between the first side surface of the electrode structure and a second side surface of the electrode structure, which is opposite the first side surface.

15. The electrode plate of claim 1, wherein the at least one slit is straight.

16. The electrode plate of claim 1, wherein the at least one slit is curved.

17. The electrode plate of claim 1, wherein a ratio of a length to a width of the at least one slit is greater than or equal to about 5:1.

18. The electrode plate of claim 1, wherein a ratio of a length to a width of the least one slit is about 5:1 to about 100:1.

19. The electrode plate of claim 1, wherein the electrode plate is has a flexibility which is greater than a flexibility of an electrode plate which does not comprise at least one slit.

20. An electrode assembly, comprising
a cathode plate;
an anode plate; and
a separator disposed between the cathode plate and the anode plate,
wherein at least one of the cathode plate and anode plate comprises:
an electrode structure comprising a current collector; an electrode active material layer disposed on at least a portion of the current collector; and
at least one slit which extends from a first side surface of the electrode structure to a point on a top surface of the electrode structure,
wherein the at least one slit extends through the current collector and the electrode active material layer.

21. The electrode assembly of claim 20, wherein the cathode plate and the anode plate each comprise a slit of the at least one slit, and
wherein a width of a slit in the anode plate is less than or equal to a width of a slit in the cathode plate.

22. The electrode assembly of claim 20, wherein the separator comprises at least one slit which has a same pattern as that of at least one of the at least one slit of the cathode plate and the at least one slit of the anode plate.

23. A secondary battery comprising the electrode assembly of claim 20.

24. A method of manufacturing an electrode plate, the method comprising:
providing a current collector;
disposing an electrode active material layer on the current collector to form an electrode structure; and
forming at least one slit in the current collector and the electrode active material layer to manufacture the electrode plate,
wherein the at least one slit extends from a first side surface of the electrode structure to a point on a top surface of the electrode structure.
